(19) United States
(12) Patent Application Publication
(10) Pub. No.: US 2022/0296032 A1
(43) Pub. Date: Sep. 22, 2022

(54) MILK FOAMING DEVICE AND METHOD FOR PRODUCING MILK FOAM

(71) Applicant: Jura Elektroapparate AG, Niederbuchsiten (CH)

(72) Inventor: Sandro KLEPZIG, Teufenthal (CH)

(73) Assignee: Jura Elektroapparate AG, Niederbuchsiten (CH)

(21) Appl. No.: 17/637,102

(22) PCT Filed: Aug. 20, 2020
(86) PCT No.: PCT/EP2020/073439

§ 371 Date: Feb. 22, 2022

(30) Foreign Application Priority Data
Aug. 22, 2019 (EP) 19193185.6

(51) Int. Cl. A47J 31/44; A47J 31/60; B01F 23/235

(52) U.S. Cl. CPC A47J 31/4485; A47J 31/60; B01F 23/235

(57) ABSTRACT

A milk foaming device for improving the quality of a milk foam (13) which is produced. The milk foaming device (1) has a mixing chamber (3) in which air (6) and milk (7) can be foamed by a steam flow (9) to provide the milk foam (13). For this purpose the respective flow rates of an air stream (15) and of a milk stream (8), each of which flows into the mixing chamber (3), are set by the air (6) and the milk (7) always flowing together into the mixing chamber (3) through an adjustable, variable opening cross-section (10) which acts as a flow rate reducer for the air stream (15) and the milk stream (8).

### TECHNICAL FIELD

The invention relates to a milk-frothing device, having a steam nozzle and a mixing chamber adjoining the steam nozzle for producing milk froth from steam, milk and air, wherein a milk flow passing into the mixing chamber is adjustable by means of a variable opening cross section.

The invention furthermore relates to a method for producing milk froth with the aid of a milk-frothing device, wherein air and milk are frothed in a mixing chamber by means of a steam flow to form the milk froth and wherein a milk flow passing into the mixing chamber is adjusted by means of a variable opening cross section.

### BACKGROUND

Such devices and methods are already known and are used in particular in fully automatic coffee machines in order to fully automatically produce milk froth for coffee beverages. In this case the milk froth is typically intended to have pores which are as fine as possible.

The user of the fully automatic coffee machine can often in addition also adjust the temperature of the milk froth by adjusting said milk flow, from which the milk froth is produced by mixing with air, such that, in the ratio to a quantity of milk to be frothed, more or less hot steam is available per unit of time for heating the milk froth. The temperature of the milk froth here typically increases the lower the milk flow is adjusted to be, i.e. the more the milk flow is throttled.

However, with this approach, the temperature of the milk froth cannot be increased as desired. This is because it can typically be observed that the fine porosity of the milk froth decreases as the temperature increases, i.e. the flow rate of the milk flow decreases, which is undesirable. The fine porosity of the milk froth can therefore typically be maintained only up to temperatures of 40-50° C.

In addition, a frequent problem is that the milk flow begins to pulsate at too low a flow rate (i.e. too low a milk flow), or breaks off entirely, which then results in an undesirable holding-up or non-uniform flowing-out of the milk froth.

EP 2 695 558 A1 discloses a fully automatic coffee machine with a milk-frothing device, in which an air flow and a milk flow are combined with the aid of a T piece and are subsequently guided through a throttle valve which can be operated from the outside with the aid of an actuating device.

WO 03/043472 A1 discloses a further device for producing milk froth, in which milk and air flow along a regulating body which can be adjusted manually with the aid of a lever in order thus simultaneously to adjust two variable opening cross sections through which the milk and the air respectively flow.

DE 10 2011 102 734 A1 discloses a device for frothing milk, which comprises, depending on the refinement, a plurality of valves and pumps which can be activated by means of a microprocessor in order to set different process parameters. In this connection, the milk is brought together with the air at a combining location which lies downstream of a respective variable opening cross section with which the milk flow or the air flow is regulated.

EP 2 732 740 A1 discloses a device for emulsifying a mixture of air, steam and milk, wherein, with a rotatable valve element, a flushing fluid can be conducted through a milk supply channel into an air chamber in order thereby to permit the cleaning of the air chamber.

### SUMMARY

Starting from these observations, the invention is based on the object of improving hitherto previously known milk-frothing devices from the prior art in respect of the quality of the output milk froth and of avoiding the aforementioned disadvantages. There is a further aim here of ensuring a fine porosity of the milk froth even at a high temperature of the milk froth.

In order to achieve this object, in the case of a milk-frothing device, one or more of the features disclosed herein are provided. In particular, in order to achieve the object in the case of a milk-frothing device of the type mentioned at the beginning, it is thus proposed according to the invention that the air is guided as an air flow through the variable opening cross section into the mixing chamber.

The variable opening cross section can act here as a throttle with which, for example, a flow rate both of the milk flow (as previously customary), but also a flow rate of the air flow can be regulated. Unlike in the case of previously known milk-frothing devices, the air flow is therefore no longer independent of the milk flow, but rather a flow rate of the air flow is dependent on a flow rate of the milk flow. The air flow is automatically reduced here as soon as the milk flow is reduced by reduction of the variable opening cross section. It can thereby be ensured that the air flow does not gain the upper hand (as in the case of previously known milk-frothing devices) and the milk flow abruptly decreases at the expense of the air flow or even entirely breaks off because the air admixing ratio has become too great. Accordingly, pulsation or non-uniform flowing-out of the milk froth from the milk-frothing device can be avoided. The effect can therefore be achieved that the air flow is also admixed with the milk flow upstream of the throttle.

An alternative solution of possibly independent inventive quality would consist, in the case of a milk-frothing device of the type described at the beginning, in an active throttling or regulating of the air flow by means of a separate air-flow regulating valve or the like, specifically for the situation in which the milk flow decreases or is actively reduced, for example by a user of the milk-frothing device.

The solution according to the invention has the advantage of proposing a particularly simple refinement with which the air flow can be automatically adapted—without additional active regulating components such as controllable valves or the like—as soon as the milk flow is varied with the aid of the variable opening cross section. In more precise terms, the air flow can be automatically reduced with the device according to the invention as soon as the milk flow is reduced.

A cause for this could be that the air together with the milk forms a common fluidic boundary surface when the air together with the milk flows through the variable opening cross section. It can thereby be prevented in flow situations, as are required for producing milk froth, that the milk flow breaks off entirely. In previous solutions which provide separate channels for air and milk that are brought together only a short distance upstream of, or in, the mixing chamber, it is by contrast entirely possible for the milk flow to break off entirely because the air flow gains the upper hand and floods the entire mixing chamber.

As a result, with the solution according to the invention, even if the milk flow is adjusted to be very low (for example in order to obtain a correspondingly high milk froth temperature), it can thus be ensured by a correspondingly great reduction in the opening cross section that the air flow is sufficiently greatly throttled. This makes it possible for fine-pored milk froth to be produced with the milk-frothing device according to the invention, even at temperatures above 50° C. If the milk flow is minimized, milk froth temperatures of 75° C. can be obtained, wherein fine-pored, creamy milk froth can be obtained even at these high temperatures.

A further advantage of the milk-frothing device according to the invention consists in that, at the beginning of drawing milk froth out of the milk-frothing device, i.e. when the flow rate of the milk flow is gradually increased from zero, a gentle outlet of milk froth can be achieved. An abrupt, sometimes explosive, outlet, as can frequently be observed in previously known milk-frothing devices, can be avoided or at least can be greatly suppressed. In other words, the milk-frothing device according to the invention can have the effect that milk froth flows uniformly, that is to say with a constant delivery rate, out of the milk-frothing device even in the event of a very low delivery rate.

The object can also be achieved by further advantageous embodiments described below and in the claims.

For example, the milk-frothing device can have a milk supply and an air supply that are configured in such a manner that the air can pass together, in particular simultaneously, with the milk through the variable opening cross section as a milk and air flow. The air flow and the milk flow can therefore thus form the milk and air flow. For this purpose, the air flow can also be combined with the milk flow upstream of the variable opening cross section, for example at an opening point at which the air supply opens into the milk supply.

Furthermore, the air flow can at least partially delimit the milk flow in the region of the variable opening cross section. In other words, the air flow can form a common fluidic boundary surface with the milk flow in the region of the variable opening cross section. Via said boundary surface, the air flow can transmit fluidic frictional forces to the milk flow such that a fluidic coupling is obtained between the milk flow and the air flow. Owing to the coupling, an increase/decrease of the air flow brings about an increase/decrease of the milk flow, and vice versa.

The variable opening cross section can accordingly be specifically dimensioned in such a manner that an adjustment of the variable opening cross section adjusts both the milk flow and the air flow, in particular simultaneously.

The effect which can be achieved in particular by such a refinement is that the air and the milk can always flow together, in particular simultaneously, through the variable opening cross section. This can preferably take place in such a manner that breaking-off and/or pulsating of the milk flow can be prevented.

Accordingly, by adjustment of the variable opening cross section, the air flow can thus be adjustable synchronously and/or in line with the milk flow. As already mentioned at the beginning, such an adjustment according to the invention can preferably take place with an additional active regulation of the air flow being dispensed with. This is because the milk-frothing device can thereby be configured in a structurally simple manner and thus manufactured cost-effectively.

For a uniform production of fine-pored milk froth, it is particularly advantageous if the variable opening cross section is mounted upstream (in the flow direction) of an admixing opening for air and milk that opens into the mixing chamber. This is because thorough mixing of the air with the milk can thereby already take place prior to entry into the actual mixing chamber, in which the actual frothing process proceeds with the aid of steam. Thus, in particular, the previously mentioned milk and air flow can be guided through the admixing opening into the mixing chamber.

A typical necessity during the use of milk-frothing devices as described at the beginning consists in regularly cleaning the milk supply in order to ensure hygiene. In principle, it would be possible for this purpose, in the case of the inventive device discussed here, to use the air supply to conduct flushing water through the air supply and thereby to clean the line portions through which the milk and the air flow together during normal operation, and—at least partially—also portions of the milk supply connected upstream of said line portions. In this case, however, there is always the risk that the flushing water is pressed, in particular counter to the normal flow direction of the air in the air supply, from the air supply into the milk supply. In the worst case scenario, the flushing water may pass as far as the milk store and contaminate the latter.

On the basis of these considerations, a further advantageous refinement for permitting reliable cleaning of the lower portions of the milk supply makes provision for said milk supply to be completely closeable, preferably by rotating a regulating body about a regulating axis, preferably in such a manner that the milk supply between a milk store and the variable opening cross section is interrupted. The closing of the milk supply, in particular the rotation of the regulating body, can take place manually here or, for example, by an appropriate automatic mechanism which is controlled by the fully automatic coffee machine. In particular, automatic cleaning of the lower portions of the milk supply in the fully automatic coffee machine can thereby be realized.

It is to be preferred here if the milk supply is completely closeable in a portion which is mounted upstream of a combining point, at which the milk flow and the air flow combine (in order subsequently to flow jointly through the variable opening cross section) with respect to a direction of flow of the milk.

The closing of the milk supply can be configured in particular (namely in particular whenever no additional line for flushing water is provided) in such a manner that, when the milk supply is completely closed, the described air supply for supplying air to the variable opening cross section is still—at least partially—open, i.e. a flow (e.g. with flushing water) can in particular flow through it.

The effect achieved by such features can be that the air supply can continue to guide air to the opening cross section while the milk supply is interrupted. If, in this situation, flushing water is then conducted through the air supply, the entire air supply can be cleaned and thereby so too can in particular those line portions through which the milk and the air jointly flow in normal operation. Therefore, in particular a portion of the milk supply which extends upstream of the variable opening cross section can be cleaned with the flushing water, wherein the flushing water is effectively prevented from flowing back into the milk store, because of the closure of the milk supply. Furthermore, the flushing water can even safely penetrate regions of the milk supply which are adjacent upstream to said combining point (and through which only milk, but not air flow during normal operation) as far as the closure and can also clean these portions.

It is particularly preferred here if, with said regulating body, not only the milk supply can be closed, but in addition also the variable opening cross section can be adjusted (as will also be explained in more detail).

The quality of the milk froth can be further increased if the milk-frothing device is structurally configured in such a manner that the milk and air flow is also guided upstream of said admixing opening through an intake chamber which is mounted upstream of the mixing chamber. For this purpose, the milk and air flow can be guided into the mixing chamber by means of a milk and air feed line. Said milk and air feed line may comprise said intake chamber. In the intake chamber, the milk and the air can be thoroughly mixed in advance. In addition, in the intake chamber, the milk and air flow can be oriented with respect to a steam flow output by the steam nozzle of the milk-frothing device, as will also be explained in more detail.

From the statement made previously, it is apparent that, according to the invention, it is preferred for the milk to be mixed with the air before the latter comes into contact with the steam. In other words, combining of the milk with the air in the milk-frothing device can thus take place upstream of said steam nozzle. Furthermore, said combining point of the milk with the air can be mounted upstream of said variable opening cross section (with respect to the flow direction of the milk/the air).

Said steam nozzle of the milk-frothing device can preferably be shaped in particular in such a manner that a steam flow can be generated, causing a negative pressure on the basis of the Venturi effect. With the aid of said negative pressure, the milk and air flow can be delivered or can be deliverable into the mixing chamber, preferably without assistance by an additional pump. As a result, the entire milk-frothing device can be configured cost-effectively without a separate delivery device (for example an additional pump).

The milk-frothing device can furthermore have an additional throughflow reducer for limiting the air flow. This is expedient in particular whenever the air flow is drawn out of the ambient air.

The throughflow reducer can be realized very simply in the form of a pinhole aperture, for example with an opening diameter of <0.5 mm. It is preferred here if, in addition or alternatively to the throughflow reducer, a lip seal is provided for preventing a flowback of milk. Said lip seal can ideally be mounted downstream of the throughflow reducer in the air flow direction in order to prevent milk from flowing through the throughflow reducer.

In all of the previous refinements, it is basically to be preferred if the opening cross section can be varied at least in a stepwise manner, but preferably continuously. This is because, in this case, a throughflow of the milk and air flow through the variable opening cross section is adjustable at least in a stepwise manner, but preferably continuously. The temperature of the milk froth can thereby be adjusted very precisely individually depending on personal requirements.

According to a preferred refinement, the opening cross section can be variable by rotation of a regulating body about a regulating axis. For this purpose, the variable opening cross section can preferably be realized by means of a surface channel of variable depth on the regulating body. Said surface channel which can primarily guide the milk flow can be configured preferably on the outer circumferential side, i.e. in particular on an outer circumference of the regulating body.

Furthermore, it can be provided in this refinement that the air is guided to the variable opening cross section by means of an air surface channel likewise formed on the regulating body. The air surface channel preferably opens here into the previously explained surface channel. In other words, the air surface channel and the surface channel (provided for the milk flow) can thus be brought together at an opening point. In this case, air and milk thus flow together through said surface channel downstream of said opening point. The variable opening cross section can be formed here at the opening point or downstream of the opening point in the surface channel.

According to a further, particularly advantageous refinement, it can also be provided that said air flow is not obtained, as customary, from the ambient air, but rather from an air supply which can be switched off. In other words, the milk-frothing device can therefore have an air switching-off device with which the air flow can be switched on and off.

If the air flow is switched off by means of the air switching-off device, air can no longer pass into the mixing chamber while the milk flow continues to be deliverable into the mixing chamber. Thus, when the air flow is switched off, a pure milk flow can be delivered by the milk-frothing device. Said pure milk flow which cannot contain any air whatsoever can be heated here with the aid of the steam nozzle. By means of such a refinement, it is possible with the milk-frothing device according to the invention to deliver a hot milk flow of up to 80° C.

It is therefore advantageous that the air supply or the air flow into the mixing chamber can be switched on and off with the aid of the switching-off device. This can be realized in particular automatically by a corresponding machine controller. For example, the switching-off device can be configured as an electrically controllable switching-off valve. A separate line thus no longer has to be provided for delivering hot milk, but rather both milk froth and hot milk can be deliverable from the milk-frothing device.

In order to achieve the object mentioned, one or more of the features of the method are provided according to the invention. In particular, in order to achieve the object, it is therefore proposed according to the invention, in the case of a method of the type described at the beginning, that the air flows into the mixing chamber through the variable opening cross section.

With this method, all of the advantages which have been explained at the beginning with respect to the device according to the invention can be realized.

Of course, it is favorable here if, in the method according to the invention, a milk-frothing device according to the invention, in particular as previously described and/or as claimed in one of the claims focused on a milk-frothing device, is used.

The method according to the invention can also have further advantageous features.

For example, the air can form an air flow which flows together, in particular simultaneously, with the milk flow as a milk and air flow through the variable opening cross section. The milk and air flow can be adjusted or regulated here in particular by adjusting the variable opening cross section. Furthermore, in the region of the variable opening cross section, the milk flow can be at least partially delimited by the air flow, as has already been explained previously.

By adjusting the variable opening cross section, both the air flow and the milk flow can be adjusted according to the method. This can take place in particular simultaneously and/or in parallel, and therefore, for example, the air flow is automatically reduced when the milk flow is reduced, and/or the air flow is automatically increased when the milk flow is increased.

Furthermore, this adjustment can preferably take place with an additional active regulation of the air flow being dispensed with.

Moreover, it is possible for air and milk to always flow together, in particular simultaneously, through the variable opening cross section, preferably without the milk flow breaking off and/or pulsating.

The steam flow can preferably be produced by means of a steam nozzle. In this case, the milk and the air can be delivered into the mixing chamber exclusively on account of a negative pressure generated by the steam nozzle of the milk-frothing device on the basis of the Venturi effect, preferably without assistance by a pump. Said delivery can preferably take place by means of a common milk and air feed line which ends in an admixing opening for air and milk that, for its part, opens into the mixing chamber.

A negative pressure can be generated in the mixing chamber by means of the steam nozzle, the negative pressure sucking up the milk together with the air from the common milk and air feed line. The common milk and air feed line can preferably comprise an intake chamber which is mounted upstream of the mixing chamber in the milk flow direction and in which the milk and air flow can be aligned with the steam flow before the milk and air flow enters the mixing chamber through the admixing opening.

According to a preferred refinement of the method, the temperature of the milk froth can be increased by the milk and air flow being reduced by a reduction of the opening cross section. In this connection, in particular, the steam flow can be kept constant or increased. Furthermore, by means of a reduction of the opening cross section, both the air flow and the milk flow can be reduced.

Finally, the air flow can be additionally reduced by means of a throughflow reducer. This can take place in particular with a throughflow reducer in the form of a pinhole aperture (cf. the explanations above) and preferably in conjunction with a lip seal (cf. above) for preventing a flowback of milk.

The opening cross section can be changed in a stepwise manner, but preferably continuously, in order thereby to adjust the milk and air flow in a stepwise manner, but preferably continuously. The temperature of the milk froth can thereby be finely regulated.

Furthermore, the opening cross section, as has already been explained previously, can be changed by rotation of a regulating body about a regulating axis. This preferably takes place by a depth, which determines the opening cross section, of a surface channel on the regulating body being varied by rotation of the regulating body.

The invention moreover comprises yet further innovative aspects and relates in this respect to a milk-frothing device having a steam nozzle for producing a steam flow, and a mixing chamber adjoining a steam outlet opening of the steam nozzle, wherein the milk is guided to an entry point into the mixing chamber. Such a milk-frothing device can be configured in particular as previously described. Furthermore, it can be used in a fully automatic coffee machine in order to deliver milk, or milk froth as previously described, for coffee beverages. The milk-frothing device described below can therefore be used to produce and to deliver milk froth.

The invention furthermore relates to an associated method for delivering milk or milk froth with the aid of a steam flow produced by a steam nozzle, wherein the milk is delivered on the basis of the Venturi effect. This method can also be used in an advantageous manner not only for delivering milk, but also milk froth. It is particularly advantageous here if, in this method, a milk-frothing device as described here is used. Said method for delivering milk can also be used in order to improve the previously explained method for producing milk froth with the aid of a milk-frothing device.

Many coffee machines, in particular fully automatic coffee machines, have a milk-frothing device, as described at the beginning, for preparing coffee specialties with milk. Since pumps are expensive, recourse is made here to the Venturi principle for delivering the milk: in this connection, a negative pressure is generated with the aid of said steam nozzle in order to suck up milk out of a container or the like, wherein the steam is mixed with the milk in said mixing chamber to form a steam and milk mixture.

The Venturi effect is based here on the fact that, when a flow cross section of the steam nozzle is constricted, the speed of the steam flow necessarily increases, which leads to a drop in the pressure. These relationships are described by the known Bernoulli equation. If the speed of the steam flow is increased, the pressure drops below ambient pressure and a negative pressure thus arises. Another fluid, i.e., for example, milk, or even solids, can then be drawn in by means of said negative pressure.

Depending on whether milk or milk froth is intended to be provided with the device, air can in addition still be added to the steam and milk mixture in order to obtain milk froth. If milk froth is delivered, the quality of the milk froth is typically endeavored to have pores which are as fine as possible.

In the case of previously known milk-frothing devices, it is frequently not optimum for an outlet jet of the milk or of the milk froth from the device not to be compact. This is frequently because the realization of the Venturi principle is pushed to its physical limits. This is true in particular whenever—for example in order to generate a high temperature of the milk or of the milk froth—the milk is delivered only at a very low delivery rate, with a constant flow rate of the steam flow. Accordingly, at very low flow rates of the milk, pulsating of the delivered milk flow or even an abrupt breaking-off of same is frequently to be observed.

Starting from these observations, it is a further object of the invention to provide a milk-frothing device and an associated method that still permit a stable delivery, even at very low flow rates.

In order to achieve this further object, it is proposed that said entry point of the milk into the mixing chamber is mounted upstream of the steam outlet opening—with respect to a direction of the steam flow.

In other words, it is accordingly proposed that the milk enters the mixing chamber in such a manner that the milk covers a distance in the direction of the steam flow before being combined with the steam flow. Since the milk typically passes as a milk flow into the mixing chamber, a portion can thus be provided within the mixing chamber, in which the milk flow flows in the same direction as the steam flow before the milk flow is combined with the steam flow to form a milk and steam flow.

Accordingly, upstream mounting of the entry point can be understood as meaning in particular an arrangement in which the entry point is arranged spaced apart from the steam outlet opening (cf. in this respect FIG. 3) counter to a direction of the steam flow in a steam outlet opening of the steam nozzle, in such an arrangement, the entry point is accordingly shifted back with respect to the steam outlet opening and the steam flow.

An advantage of all of these refinements is that a flow direction of the milk flow can be oriented in the direction of the steam flow before the milk flow is combined with the steam flow. Unlike in the case of previously known devices, the milk flow thus no longer impinges on the milk flow at a more or less large angle, in particular right angle, but rather the milk flow is applied tangentially to the steam flow and is conveyed uniformly here by the steam flow.

It can be observed as a result that, with the solution according to the invention, a milk jet or milk froth jet delivered with the device emerges much more gently from the mixing chamber, this being in particular acoustically perceptible. This uniform flowing-out owing to a continuous delivery rate can be maintained here even at very low delivery rates, because of the more stable realization of the Venturi principle by the novel arrangement of the entry point and the associated novel feeding of the milk flow to the steam flow conveying the latter.

According to further embodiments, for example, an admixing opening for milk or else for milk and air can be provided, said admixing opening defining the entry point and opening into the mixing chamber. Said admixing opening can now be oriented rectilinearly and/or shaped in such a manner that the milk is fed as a milk flow in the direction of the steam flow to the steam flow. Said feeding can be configured in particular in such a manner that, in a region in which the milk flow makes contact with the steam flow and/or is combined with the steam flow, a flow direction of the milk flow runs tangentially with respect to a flow direction of the steam flow. In this case, after milk and steam are combined, the flow direction of the milk flow can precisely coincide with that of the steam flow, in particular in such a manner that milk and steam flow further in the form of a joint milk and steam flow.

The feeding can furthermore preferably be configured in such a manner that, in a region of the mixing chamber mounted upstream of the steam outlet opening, the milk flow flows in the direction of the steam flow, in particular along an outer surface of the steam nozzle. This is possible, for example, if a steam outlet opening of the steam nozzle and said admixing opening point in the same direction.

For this purpose, the admixing opening can preferably be formed annularly and/or arranged concentrically with respect to the steam nozzle. Furthermore, it is advantageous if the admixing opening is mounted upstream of the steam outlet opening. The effect which can be achieved by such refinements is in particular that the steam flow emerging from the steam outlet opening is encased annularly by a casing flow of milk or of milk and air flowing in the direction of the steam flow, which has the result of delivering milk particularly uniformly into the mixing chamber.

According to a further preferred refinement, an outer surface of the steam nozzle can delimit the entry point, that is to say in particular said admixing opening, at least in sections. This is possible, for example, if the admixing opening is arranged annularly around the steam nozzle.

Furthermore, the entry point can be formed in particular by means of a constriction. Said constriction can separate an intake chamber, which is mounted upstream of the mixing chamber, from the mixing chamber. Such an intake chamber is advantageous in order to orient the milk flow prior to entry into the mixing chamber. Furthermore, the intake chamber can also be used to mix milk with air to form a milk and air flow which can then pass through the admixing opening into the mixing chamber.

The intake chamber can also annularly surround the steam nozzle, which is advantageous in particular when an annular admixing opening is used.

It is very particularly advantageous if the intake chamber and/or the steam nozzle have/has a deflecting surface for deflecting the milk flow in the direction of the steam flow. This is because, with such a deflecting surface, it is possible to orient a milk flow, which initially runs at an angle, in particular right angle, to the steam flow, in the direction of the steam flow.

The deflection of the milk flow by means of one or more deflecting surfaces can be configured in particular in such a manner that the milk flow already passes through the admixing opening in the direction of the steam flow, which results in a particularly gentle delivery of milk.

According to one specific refinement, it is furthermore advantageous, for a uniform delivery rate, if a distance between the entry point and the steam outlet opening is greater than a clear diameter of the steam outlet opening and/or than a clear width of the admixing opening and/or than an outer diameter of the steam nozzle at the location of the steam outlet opening. By means of such refinements, it is in each case ensured that the milk flow is combined with the steam flow without relatively great turbulence, as may arise during passage through the admixing opening, and therefore the milk and steam flow which arises is delivered uniformly.

In order to produce particularly fine-pored milk froth, an atomization chamber which is mounted downstream of the mixing chamber in the steam flow direction can be formed. Said atomization chamber, which serves for producing an aerosol of milk and air, i.e. milk froth, can be separated from the mixing chamber, preferably by means of a constriction. Furthermore, the atomization chamber can have an impact body for atomizing milk. Said impact body can form a planar surface which is oriented at a right angle to the steam and milk flow. Such an atomization chamber can therefore be favorable for sufficiently thoroughly mixing the milk with the air and the steam.

In order to improve the production of milk froth with pores which are as fine as possible, the milk-frothing device, between the mixing chamber and the atomization chamber, can form an acceleration portion for accelerating a steam and milk mixture.

For a uniform delivery rate of the milk flow or of the milk and steam flow, it is furthermore crucial for the milk to be mixed with the steam without relatively great turbulence. For this purpose, it is proposed that the mixing chamber has a collecting funnel which collects and combines the steam flow and milk flow. Said collecting funnel is preferably aligned with the steam outlet opening, in particular in such a manner that an axis of rotation of the collecting funnel coincides with a steam outlet direction. Furthermore, it is advantageous if the steam funnel is constricted in the steam flow direction. The steam funnel can furthermore open into said acceleration portion.

As has already been explained, a milk flow which is delivered by the milk-frothing device and which flows into the mixing chamber at the entry point can still be adjustable upstream of the entry point by means of a variable opening cross section.

If milk froth is intended to be delivered, the milk-frothing device can have an air supply. Said air supply can be configured in such a manner that, in particular at the same time as the milk flow, an air flow can be conducted through the variable opening cross section.

Therefore, in particular, a milk and air flow can thus be guided into the mixing chamber at the entry point.

Accordingly, in other words, the milk flow can have an air portion and can thus pass as a milk and air flow into the mixing chamber. As a result, in particular, a steam and milk and air mixture can therefore arise in the mixing chamber. And then, from the steam and milk and air mixture, a milk froth can be produced by corresponding turbulent swirling in said atomization chamber.

With the variable opening cross section, through which the air and the milk can flow as a milk and air flow, a flow rate of the milk and air flow can be adjusted. The ratio between air and milk can be maintained here since the milk entrains the air as it flows through the opening cross section. As a result, the milk flow can no longer be broken off—as can frequently be observed previously in the prior art—and this is of great advantage for a continuous delivery rate of the milk.

One refinement of the previously explained method for delivering milk makes provision for the milk to be oriented as a milk flow along the steam flow. It is thus possible to avoid or at least reduce turbulence during the combining of the milk flow with the steam flow, which turbulence can lead to a nonuniform production of milk froth.

Accordingly, in particular as an alternative to the orientation of the milk flow, it can preferably, however, additionally be provided that the milk is guided into the mixing chamber at an entry point which is mounted upstream of a steam outlet opening of said steam nozzle—with respect to a direction of the steam flow. The longitudinal direction or flow direction of the steam flow can preferably be defined here by the steam outlet opening of the steam nozzle.

Such a method realizes all of the advantages described previously with respect to the associated device, in particular a uniform delivery of the milk, even at very low delivery rates of the milk.

It is very particularly advantageous for an efficient and as gentle a delivery of milk as possible, i.e. free from disturbances, on the basis of the Venturi principle if the milk flow is oriented in the steam flow direction, before the steam flow is combined with the milk in a mixing chamber. Said mixing chamber, in particular as already described previously, can adjoin a steam outlet opening of the steam nozzle. Combining can be understood here as meaning the point at which the milk flow and the steam flow come into contact and are combined to form a joint milk and steam flow, with it not yet being necessary for turbulent mixing of the milk with the steam to have to take place; on the contrary, this can take place first in a downstream atomization chamber.

Such a guide of the milk flow can be particularly simply obtained with the aid of an admixing opening which is mounted upstream of a steam outlet opening of the steam nozzle. Said admixing opening can be configured as already described previously and can be oriented in particular in the direction of the steam flow output by the steam nozzle. By means of the above measures, the milk flow can be guided in particular in such a manner that the milk flow already flows in the direction of the steam flow when said milk flow flows into the mixing chamber, in particular through said admixing opening.

Such a milk flow can be produced, for example, when the milk flow is oriented by means of at least one deflecting surface in an intake chamber mounted upstream of the mixing chamber.

Furthermore, it is advantageous for an efficient conveying of the milk flow, even at low delivery rates, if the milk flow flows into said mixing chamber concentrically with respect to the steam nozzle.

This can be achieved, for example, if the milk flow in a region that is mounted upstream of a steam outlet opening of the steam nozzle flows in the steam flow direction along an outer surface of the steam nozzle.

In order to obtain structural advantages, for example in order to optimally use space in a fully automatic coffee machine, it may be advantageous if the milk flow flows into the previously explained intake chamber transversely with respect to the direction of the steam flow. The milk flow can subsequently then be deflected by 90° by means of the deflecting surfaces in order to orient the milk flow with respect to the steam flow.

In order also to avoid turbulent flows in the region of the steam nozzle, it can be provided according to the invention that the milk flow is combined with the steam flow in the mixing chamber by means of a collecting funnel. The collecting funnel can preferably be rotationally symmetrical here and/or can be oriented with respect to a steam outlet opening of the steam nozzle.

In all of the previously explained embodiments, it can also be provided that the milk flow has an air portion for forming a steam and milk and air mixture. Said air portion can be admixed to the milk flow in the form of an air flow, specifically before the milk and air flow thus arising passes into the mixing chamber, in order to be mixed there with the steam flow to form a steam and milk and air mixture.

Specifically when hot milk froth is intended to be produced, it is particularly advantageous if said air portion is conducted as an air flow together with the milk flow as a milk and air flow through a variable opening cross section, before the milk and air flow passes into the mixing chamber. The advantages of such a procedure consist in that the air flow can no longer get out of control, and therefore, even at low delivery rates, a desired ratio of air to milk can always been maintained, which has already been explained with reference to the device according to the invention and will also be explained once again with reference to the figures.

The invention will now be described in more detail with reference to exemplary embodiments, but is not restricted to these exemplary embodiments.

Further exemplary embodiments emerge from combination of the features of individual claims or a plurality of claims with one another and/or with individual features or a plurality of features of the respective exemplary embodiment. In particular, embodiments of the invention can therefore be obtained from the description below of a preferred exemplary embodiment in conjunction with the general description, the claims and the drawings.

### BRIEF DESCRIPTION OF THE DRAWINGS

In the drawings:

FIG. 1 shows a perspective view of a milk-frothing device according to the invention,

FIG. 2 shows a perspective view of a longitudinal section of the milk-frothing device from FIG. 1,

FIG. 3 shows a top view of the longitudinal section according to FIG. 2,

FIG. 4 shows a side view of the milk-frothing device from FIG. 1,

FIG. 5 shows a view from above of the milk-frothing device from FIG. 1,

FIG. 6 shows a perspective detailed view of a partial vertical section through the milk-frothing device of FIG. 1 along the section line shown in FIG. 5,

FIG. 7 shows a top view from above of a horizontal section through the regulating body in the position according to FIG. 6,

FIG. 8 shows the detailed view from FIG. 6 after rotation of the regulating body of the milk-frothing device by 90° in the clockwise direction,

FIG. 9 shows a top view from above of a horizontal section through the regulating body in the position according to FIG. 8, in analogy to FIG. 7,

FIG. 10 shows a perspective detailed view of the regulating body of the milk-frothing device from FIG. 1 in the 0° position shown in FIG. 1 and FIG. 6,

FIG. 11 shows a detailed sectional view of a mixing chamber of the milk-frothing device of FIG. 1, and

FIG. 12 shows a detailed view of the regulating body of the milk-frothing device from FIG. 1, wherein said regulating body precisely closes the milk supply (12).

### DETAILED DESCRIPTION

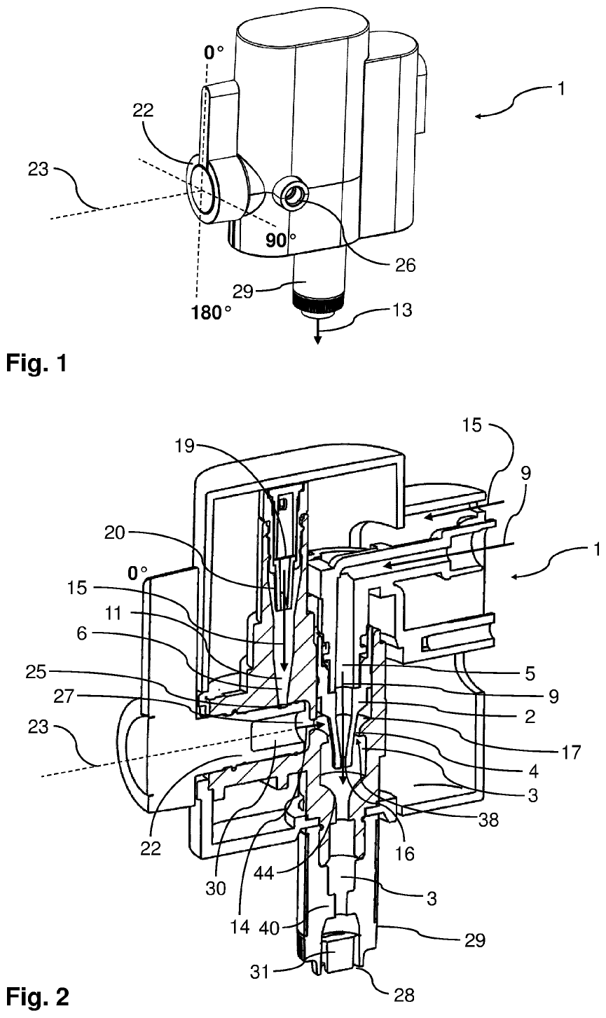

FIG. 1 shows a milk-frothing device according to the invention, denoted as a whole by 1, which is provided for use on a fully automatic coffee machine with which various coffee beverages can be provided.

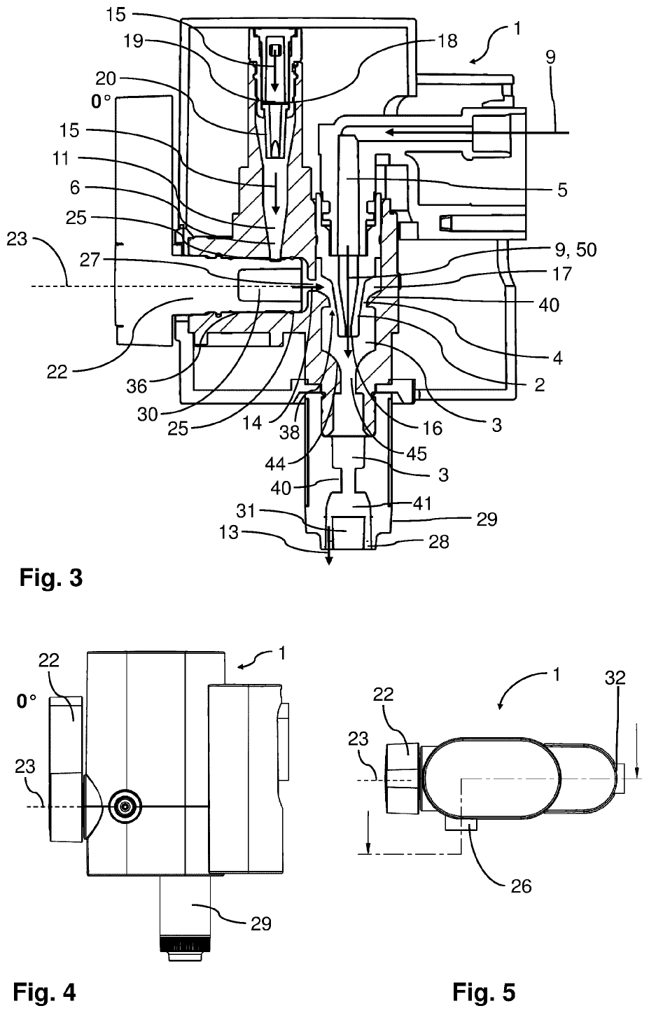

As can readily be seen in FIGS. 2 and 3, the milk-frothing device 1 has a steam nozzle 2 with which a steam flow 9 can be produced which exits from a steam outlet opening 16 and flows into a mixing chamber 3 mounted downstream of the steam nozzle 2. For this purpose, a steam supply connection 32 is also provided, from which steam 5 passes into the steam nozzle 2.

With the aid of the steam flow 9, both milk 7 and air 6 can be delivered into the mixing chamber 3 using the Venturi effect, in order to froth the milk 7 and the air 6 there to form a stable milk froth 13. In order to configure the milk-frothing device 1 in a structurally simple manner, an additional pump has been omitted here, and therefore the milk 7 and the air 6 are delivered as a milk and air flow 14 into the mixing chamber 3 exclusively because of the negative pressure generated by the steam nozzle 2.

In order to froth the milk 7, an impact body 31 is provided in the mixing chamber 3, at which impact body turbulent swirling of the milk 7 and of the air 6 occurs, such that fine-pored milk froth 13 arises which then flows out of a milk-froth outlet opening 28 of the discharge module 29, which is shown in FIGS. 2 and 3.

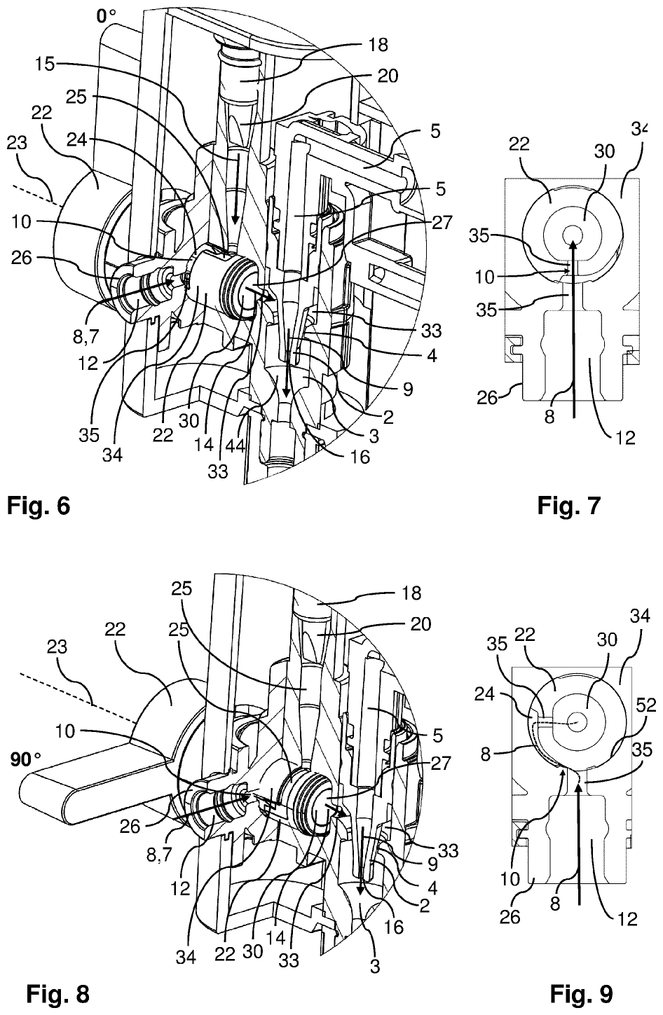

The milk 7 is supplied here to the milk-frothing device 1 via a milk supply connection 26 and an adjoining milk supply 12, which can be seen in FIG. 1, and therefore a milk flow 8 (cf. FIG. 6) is guided into the mixing chamber 3. Furthermore, a corresponding air supply 11 is also provided, with which an air flow 15 is guided into the mixing chamber 3, wherein the air flow 15 is obtained from the ambient air, as can be seen with reference to FIGS. 2 and 3.

The milk-frothing device 1 furthermore has a regulating body 22 which is mounted rotatably about a regulating axis 23. A variable opening cross section 10 which reduces or adjusts a throughflow rate of the milk flow 8 is adjustable with the regulating body 22. As will be explained more precisely, a flow rate of the milk flow 8 can be precisely and continuously adjusted here by a rotation of the regulating body 22.

Since the steam nozzle 2 substantially produces a constant steam flow 9, the temperature of the emerging milk froth 13 can be adjusted with the aid of the regulating body 22. This is because, as soon as the flow rate of the milk flow 8 is reduced while the flow rate of the steam flow 9 remains substantially constant, the temperature of the milk froth 13 correspondingly increases. This means that particularly high temperatures of the milk froth 13 are achieved precisely when the flow rate of the milk flow 8 is at the lowest.

In order now in such a situation to prevent the milk flow 8 from breaking off and only air 6 from flowing into the mixing chamber 3, according to the invention the air flow 15 is guided through the variable opening cross section 10 into the mixing chamber 3.

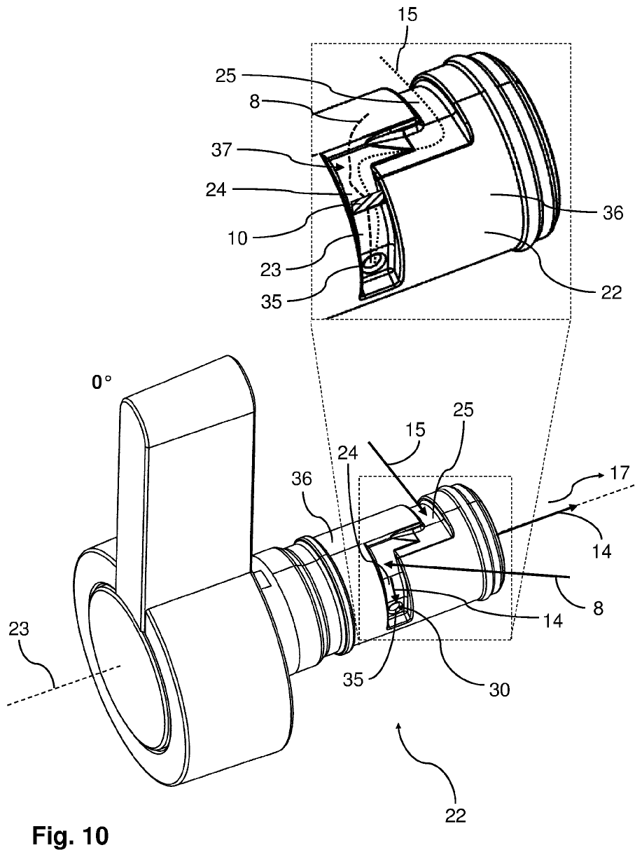

As the detailed view of the regulating body 22 according to FIG. 10 shows, the regulating body 22 has, for this purpose, a first surface channel 24 for guiding the milk 7 or the milk flow 8 and an air surface channel 25 for guiding the air 6 or the air flow 15. Said two surface channels 24, 25 are each formed on the outer circumferential side in a circumferential outer surface or in an outer contour 36 of the regulating body 22. The circumferential outer surface/outer contour 36 of the regulating body 22 is formed cylindrically here in order to permit a rotation of the regulating body 22, as the detailed view of FIG. 10 shows.

It is apparent with reference to the detailed views according to FIGS. 6 and 8 that the regulating body 22 is mounted in a sealing manner in a regulating body receptacle 34 formed so as to correspond to the regulating body 22. An inner surface of the regulating body receptacle 34 with the respective surface channel 24, 25 defines a respective throughflow cross section which at the same time determines a flow rate of the milk flow 8 or of the air flow 15.

As the detailed view of FIG. 10 shows, a channel depth of the surface channel 24 is configured so as to be variable in the circumferential direction. The respective channel depth of the surface channel 24 together with the regulating body receptacle 34 determines the variable opening cross section 10 through which both the air flow 15 and the milk flow 8 are guided, as can be seen with reference to the dashed and dotted lines in the detailed view of FIG. 10. For this purpose, the air surface channel 25 opens into the surface channel 24, and therefore, at the opening point 37 shown in FIG. 10, the air supply 11 and the milk supply 12 are precisely brought together, specifically still upstream of the variable opening cross section 10. In other words, the air 6 or the air flow 15 is thus guided with the aid of the air surface channel 25 to the opening point 37 and from there to the variable opening cross section 10.

In other words, the cross-sectional surface of the opening cross section 10 is therefore varied as soon as the regulating body 22 is rotated. This variation takes place continuously, and therefore the opening cross section 10 can be varied continuously by rotation of the regulating body 22. Consequently, a flow rate of the milk and air flow 14 through the variable opening cross section 10 can thereby be varied continuously.

In the 0° position of the regulating body 22 that is shown in FIGS. 6 and 7, the variable opening cross section 10 is determined here precisely by a through opening 35 which opens into a chamber 30 in the interior of the regulating body 22 (cf. FIG. 7 together with FIG. 3). In this position of the regulating body 22, both the air flow 15 and the milk flow 8 thus flow through the inflow opening 33, which acts as the variable opening cross section 10, into the chamber 30 and from there as a milk and air flow 14 through an inflow opening 33 into an intake chamber 17 and from there through an admixing opening 4 into the mixing chamber 3 (cf. FIGS. 6 and 8).

By contrast, in the 90° position of the regulating body 22 that is shown in FIGS. 8 and 9, both the air flow 15 and the milk flow 8 flow in the surface channel 24 initially along the circumference of the regulating body 22, then through the variable opening cross section 10, illustrated as a hatched area in FIG. 10, and only then through the through opening 35 into the chamber 30 in order to pass from there into the intake chamber 17 and finally into the mixing chamber 3. In this situation, it is therefore precisely the cross-sectional area, which is illustrated as a hatched area in FIG. 10, which is the determining feature for the throughflow of the milk and air flow 14, and it therefore acts as the variable opening cross section 10 within the context of the invention.

In both situations (FIG. 6/FIG. 8), the air 6 together and simultaneously with the milk 7 passes through the variable opening cross section 10 as a milk and air flow 14, wherein the air flow 15 mentioned at the beginning and the milk flow 8 mentioned at the beginning form the milk and air flow 14.

As is easily conceivable with reference to the detailed view of FIG. 10, the two fluids, i.e. the milk 7 and the air 6, flow next to each other through the variable opening cross section 10 and in the process form a common fluidic boundary surface via which the two fluids interact with each other. This has the result that, in the region of the variable opening cross section 10, the air flow 15 at least partially delimits the milk flow 8. The remaining delimitation is provided here by the walls of the surface channel 24 and by the inner surface of the regulating body receptacle 34.

In this connection, the variable opening cross section 10 that is determined by the variable channel depth of the surface channel 24 is dimensioned precisely in such a manner that an adjustment of the variable opening cross section 10 adjusts both the milk flow 8 and the air flow 15 simultaneously and in particular in parallel by rotation of the regulating body 22. This means that, in the event that the variable opening cross section 10 is reduced from the 0° position shown in FIG. 6 into the 90° position shown in FIG. 8 by a rotation of the regulating body 22, both a flow rate of the milk flow 8 and at the same time a flow rate of the air flow 15 is reduced. Therefore, the air flow 15 is thus automatically throttled as soon as the milk flow 8 is reduced, for example in order to achieve a high temperature of the emerging milk froth 13.

Owing to the fluidic coupling between the milk flow 8 and the air flow 15, said coupling arising by means of the common fluidic boundary surface, it is virtually no longer possible for the milk flow 8 to break off.

As can be readily seen in particular in the longitudinal sectional view of FIG. 3 (in conjunction with FIG. 3), the variable opening cross section 10 is precisely mounted upstream of the admixing opening 4, through which air 6 and milk 7 pass into the mixing chamber 3, with respect to the flow direction of the milk and air flow 14. Furthermore, it can be seen that the milk and air flow 14 is still guided upstream of the admixing opening 4 through the intake chamber 17, which is mounted upstream of the mixing chamber 3.

The through opening 35, the chamber 30, the inflow opening 33, the intake chamber 17, and the admixing opening 4 thus form a milk and air feed line 21 which guides the milk and air flow 14 from the variable opening cross section 10 into the mixing chamber 3.

As can be seen, for example, in FIGS. 2, 3 and 6, the air 6 first of all flows through a throughflow reducer 18 in the form of a pinhole aperture 19 and then through a lip seal 20. While the pinhole aperture 19 reduces a flow rate of the air flow 15, the lip seal serves to prevent a possible backflow of the milk 7 in the direction of the pinhole aperture 19.

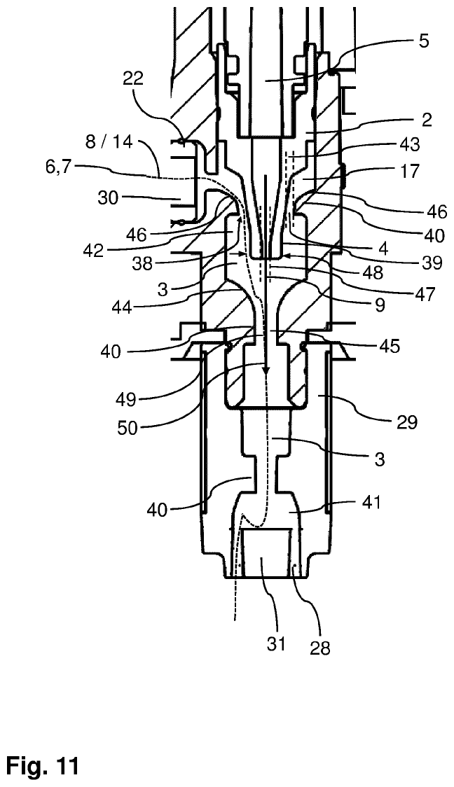

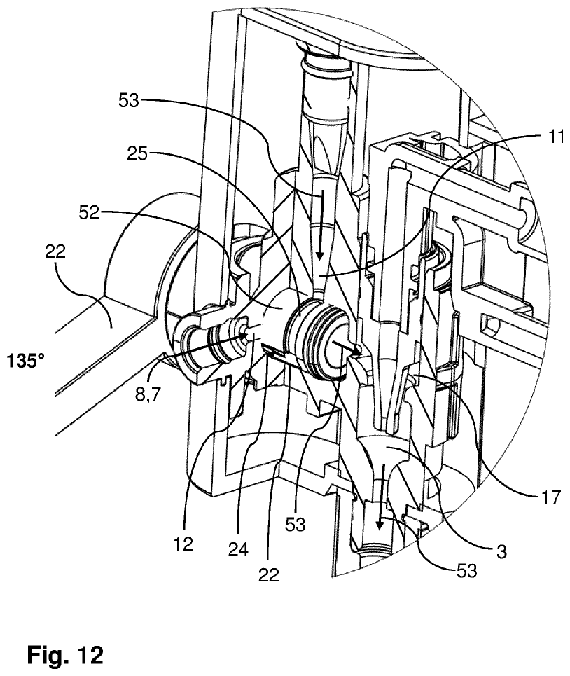

FIG. 12 illustrates a further characteristic feature of the regulating body 22 of the milk-frothing device from FIG. 1. Said regulating body has a closure surface 52, and therefore the milk supply 12 can be completely closed by corresponding rotation of the regulating body 22 into the 135° position illustrated in FIG. 12. In this position of the regulating body 22, that is to say with the milk supply 12 completely closed (wherein the milk supply 12, as can be seen in FIG. 12, is interrupted precisely between the milk store (not shown) and the variable opening cross section 10), a flow can continue to pass through the air supply 11. More specifically, air can continue to flow first of all from the throughflow reducer 18 through the air surface channel 25 (cf. FIG. 10) and then through the surface channel 24 (through which the milk normally also flows) and the variable opening cross section 10 and can thus pass through the through opening 35 into the chamber 30 (cf. in this respect also FIG. 3 and FIG. 10). This also becomes vividly clear if it is imagined rotating the regulating body 22 in FIG. 9 by a further 45° in the clockwise direction (as a result of which the situation of FIG. 11 is reached, in which the milk flow 8 impinges on the closure surface 52 and thus can no longer pass into the chamber 30).

Since the regulating body 22 in FIG. 12 therefore has now been rotated precisely to such an extent that the milk supply 12 is closed, but the air supply 11 continues to be open, the entire lower portion of the milk supply 12 can now be flushed without there being the risk of flushing water being pushed into the upper portion of the milk supply 12 and as far as into the milk store.

For this purpose, flushing water can be introduced as a flushing water flow 53, as illustrated in FIG. 12, into the air supply 11, for example on the same path as the air through the throughflow reducer 18 or via a separate feed line. As a result, the flushing water flow 53 can flow through the surface channels 24 and 25, the through opening 35 and finally the chamber 30 in order subsequently to pass through the intake chamber 17 into the mixing chamber 3 and, finally, to emerge through the milk froth outlet opening 28 (cf. FIG. 3). Therefore, at least all of the line portions through which the milk and the air jointly flow during normal operation can be cleaned with flushing water, such that, in addition, only the upper portion of the milk supply 12 as far as the closure surface 52 of the regulating body 22 has to be cleaned by hand, in order to ensure hygiene.

The above-described flushing can be carried out here fully automatically by a fully automatic coffee machine which is based on such a milk-frothing device 1, wherein the fully automatic coffee machine can control both the active flushing and the closing of the milk supply 12.

The Figures do not show a further possible refinement of the milk-frothing device 1, in which the air flow 15, which flows into the mixing chamber 3 through the variable opening cross section 10, can be switched on or off by means of an air switching-off device in the form of an electrically activatable blocking valve. If the air switching-off device is activated by the fully automatic coffee machine, no more air 6 can flow into the mixing chamber 3, but milk 7 can continue to flow through the variable opening cross section 10 into the mixing chamber 3. In this case, the milk-frothing device 1 therefore specifically does not deliver any milk froth 13 through the milk-froth outlet opening 28, shown in FIG. 3, of the discharge module 29, but rather delivers milk 7 heated by the steam 5. In such a refinement, both milk froth 13 and hot milk 7 can therefore be output by the milk-frothing device 1.

In summary, the invention aims to improve the quality of a milk froth 13 which is produced by means of a milk-frothing device 1 which has a mixing chamber 3 in which air 6 and milk 7 can be frothed by means of a steam flow 9 to form the milk froth 13. It is proposed for this purpose that a respective flow rate of an air flow 15 and of a milk flow 8, which each flow into the mixing chamber 3, is adjusted by the fact that the air 6 and the milk 7 always flow together into the mixing chamber 3 through an adjustable, variable opening cross section 10 which acts as a flow rate reducer or as a throttle for the air flow 15 and the milk flow 8. In other words, in the solution according to the invention, a variable opening cross section 10 is therefore provided through which an air flow 15 is guided together with a milk flow 8.

Considered from a different viewing angle which discloses further innovative aspects of the present invention, FIG. 1 shows a milk-frothing device according to the invention that is denoted overall by 1 and is provided for use on a fully automatic coffee machine with which various coffee beverages can be provided, wherein the milk-frothing device 1 conveys milk for the coffee beverages through the fully automatic coffee machine and finally into a cup.

As can be seen in FIG. 2, the milk-frothing device 1 has a steam nozzle 2 for producing a steam flow 9, and a mixing chamber 3 which adjoins a steam outlet opening 16 of the steam nozzle 2. The delivered milk 7 is guided here as a milk flow 8 along the flow path, shown in FIG. 11 as a dashed line (and provided with reference signs 8/14) through an admixing opening 4 into the mixing chamber 3. The admixing opening 4 opens here into the mixing chamber 3 and therefore defines the entry point 38.

As can readily be seen in particular in FIGS. 2 and 11, the entry point 38 is mounted upstream of the steam outlet opening 16, specifically with respect to the direction of the steam flow 9 that is illustrated in the Figures with the aid of a straight arrow running through the steam outlet opening 16. The upstream mounting is dimensioned here in such a manner that the distance (vertical in the Figures) that can be measured in FIG. 2 and even better in FIG. 11 between the entry point 38 and the steam outlet opening 16 is greater than the clear diameter 47 of the steam outlet opening 16, is greater than a clear width 43 of the admixing opening 4 and even is greater than an outer diameter 48 of the steam nozzle 2 at the location of the steam outlet opening 16.

This ample upstream mounting of the entry point or extension of the steam nozzle 2 (in each case in comparison to previously known devices) achieves the flow guide that is illustrated in FIG. 11 with the aid of the dashed line and in which the milk 7 is fed as a milk flow 8 in the direction of the steam flow 9 (compare the arrow in FIG. 11) to the steam flow 9. As can be seen in FIG. 11, the milk flow 8 already flows here in a region 42 of the mixing chamber 3 that is mounted upstream of the steam outlet opening 16, in the direction of the steam flow 9. This is seen in particular by way of the dashed line in the region 42 where the milk flow 8 flows along an outer surface 39 of the steam nozzle 2.

It can be seen even more precisely in FIG. 11, but even better in FIG. 2, that the steam nozzle 2 at the same time delimits the admixing opening 4 and thus at the same time defines the entry point 38. This is because said admixing opening 4 is configured annularly and is arranged concentrically with respect to the steam nozzle 2, as is readily seen in the perspective view of FIG. 2 or, for example, in FIGS. 6 and 8.

The entry point 38 is formed here by a constriction 40 (cf. FIG. 3) which separates an intake chamber 17, which is mounted upstream of the mixing chamber 3 in the flow direction of the milk flow 8, from the mixing chamber 3. The milk flow 8 flows as a milk and air flow 14 into the intake chamber 17. In other words, the milk flow 8 thus contains an air portion, the purpose of which will be explained more precisely further below.

The intake chamber 17 annularly surrounds the steam nozzle 2 (compare FIGS. 2 and 6) and forms a deflecting surface 46 that is likewise formed annularly. By means of said deflecting surface 46, the milk flow 8 flowing into the intake chamber 17 initially transversely with respect to the steam flow 9 is deflected in such a manner that the milk flow 8 already passes through the admixing opening 4 in the direction of the steam flow 9, which can be readily seen with reference to the dashed line in FIG. 11.

More precisely, the milk flow 8 already flows in the intake chamber 17 around the steam nozzle 2 and then enters as a casing flow through the annular admixing opening 4 into the mixing chamber 3. Subsequently, the milk flow 8 as a casing flow converges continuously with the steam flow 9 and encases the latter in the form of a casing until it is combined therewith to form a steam and milk flow 49 (cf. FIG. 11).

More precisely, this combining takes place with the aid of a collecting funnel 44 (cf. FIGS. 6 and 11) which is formed in the mixing chamber 3 and which collects and combines the milk 7 and the steam 5. The collecting funnel 44 is constricted here in the direction of the steam flow 9, with said collecting funnel being oriented precisely centrally with respect to the steam outlet opening 16 (cf. FIG. 11).

By means of this further constriction 40, the mixing chamber 3 is separated from a downstream atomization chamber 41, wherein at the same time an acceleration portion 45 for accelerating the steam and milk flow 49 is formed by the constriction 40 (cf. FIG. 11). The steam and milk flow 49 thereby flows at high speed into the downstream atomization chamber 41 and impacts there against a centrally arranged impact body 31, as a result of which the steam and milk flow 49 is turbulently swirled and therefore heat is transmitted from the hot steam 5 to the milk 7 to be heated.

As a result, the previously described device 1 can deliver milk at temperatures of up to 80° C. from the milk outlet opening 28 (cf. FIG. 3) without—despite a very low delivery rate—the milk flow 8 breaking off.

If milk froth is intended to be produced with the milk-frothing device 1, the milk-frothing device 1 delivers a milk flow 8 containing an air portion into the mixing chamber 3. If said milk and air flow 14 is swirled with the steam 5 in the atomization chamber 41, milk froth is produced.

In such a case, it is very particularly advantageous if the milk-frothing device 1 has a variable opening cross section 10 which has already been explained previously and through which an air flow 14 can be conducted, preferably simultaneously with the milk flow 8. This is because, as will be explained in more detail, it can thereby be ensured, even at low delivery rates, that the milk flow 8 does not break off because the air flow 14 gains the upper hand.

In summary, the invention according to a first aspect for a milk-frothing device 1, which delivers milk 7 on the basis of the Venturi effect with the aid of a steam flow 9 output by a steam nozzle 2, proposes coupling an adjustment of a milk supply to an adjustment of an air supply by milk and air being conducted via a common, variable, in particular adjustable, opening cross section 10.

The invention therefore aims to improve the quality of a milk froth 13 which is produced by means of a milk-frothing device 1 which has a mixing chamber 3 in which air 6 and milk 7 can be frothed by means of a steam flow 9 to form the milk froth 13. For this purpose, it is proposed that a respective flow rate of an air flow 15 and also of a milk flow 8, which each flow into the mixing chamber 3, is adjusted by the fact that the air 6 and the milk 7 always flow together into the mixing chamber 3 through an adjustable, variable opening cross section 10 which acts as a flow rate reducer for the air flow 15 and the milk flow 8.

According to a second aspect, it is proposed, by means of corresponding orientation of an admixing opening 4 and optionally with the aid of deflecting surfaces 46, to allow a milk flow 8, which is sucked up by a steam flow 9, to flow tangentially onto the steam flow 9 in order thereby to still be able to ensure delivery of the milk flow 8 as far as possible without disturbance, even at very low flow rates of the milk flow 8. For this purpose, before the milk flow 8 enters into contact with the steam flow 9, the milk flow 8 is oriented in the direction of the steam flow 9.

### LIST OF REFERENCE SIGNS

1 Milk-frothing device
2 Steam nozzle
3 Mixing chamber
4 Admixing opening
5 Steam
6 Air
7 Milk
8 Milk flow
9 Steam flow
10 Variable opening cross section
11 Air supply
12 Milk supply
13 Milk froth
14 Milk and air flow
15 Air flow
16 Steam outlet opening
17 Intake chamber
18 Throughflow reducer (for 15)
19 Pinhole aperture
20 Lip seal
21 Milk and air feed line
22 Regulating body
23 Regulating axis
24 Surface channel (for 7/8)
25 Air surface channel (for 6/15)
26 Milk supply connection
27 Milk and air feed line
28 Milk froth outlet opening
29 Discharge module
30 Chamber
31 Impact body
32 Steam supply connection
33 Inflow opening
34 Regulating body receptacle
35 Through opening
36 Outer contour (of 22)
37 Opening point
38 Entry point (for 7 into 3)
39 Outer surface (of 2)
40 Constriction
41 Atomization chamber
42 Region (of 3)
43 Clear width (of 4)
44 Collecting funnel
45 Acceleration portion
46 Deflecting surface
47 Clear diameter (of 16)
48 Outer diameter (of 2)
49 Steam and milk flow
50 Milk-frothing device
51 Direction of the steam flow
52 Closure surface
53 Flushing water flow

1. A milk-frothing device (1), comprising:
a steam nozzle (2);
a mixing chamber (3) adjoining the steam nozzle (2) for producing milk froth (13) from steam (5), milk (7) and air (6);
a variable opening cross section (10) configured for adjusting a milk flow (8) passing into the mixing chamber (3);
wherein the air (6) is guided as an air flow (15) through the variable opening cross section (10) into the mixing chamber (3);
a milk supply (12) and an air supply (11) configured such that the air (6) simultaneously with the milk (7) pass through the variable opening cross section (10) as a milk and air flow (14); and
a regulating body (22) configured to permit a reliable cleaning of lower portions of the milk supply (12) by the milk supply (12) being completely closeable with the regulating body (22) with which, in addition, the variable opening cross section is also adjustable, and when the milk supply (12) is completely closed, the air supply (1) can still have a flow passing therethrough.

2. The milk-frothing device (1) as claimed in claim 1, wherein at least one of (a) the air flow (15) and the milk flow (8) form the milk and air flow (14),
(b) in a region of the variable opening cross section (10), the air flow (15) at least partially delimits the milk flow (8), or
(c) the milk supply (12) is closeable such that the milk supply (12) between a milk store and the variable opening cross section (10) is interrupted.

3. The milk-frothing device (1) as claimed in claim 1, wherein the variable opening cross section (10) is dimensioned such that an adjustment of the variable opening cross section (10) adjusts both the milk flow (8) and the air flow (15).

4. The milk-frothing device (1) as claimed in claim 1, wherein the variable opening cross section (10) is mounted upstream of an admixing opening (4) for air (6) and milk (7) that opens into the mixing chamber (3).

5. The milk-frothing device (1) as claimed in claim 4, further comprising an intake chamber (17) mounted upstream of the mixing chamber (3), and the milk and air flow (14) is also guided upstream of the admixing opening (4) through the intake chamber (17).

6. The milk-frothing device (1) as claimed in claim 1, wherein the steam nozzle (2) is shaped such that a steam flow (9) is generatable, causing a negative pressure based on a Venturi effect,
such a manner that the milk and air flow (14) is deliverable into the mixing chamber (3) by the negative pressure.

7. The milk-frothing device (1) as claimed in claim 1, further comprising an additional throughflow reducer (18) for limiting the air flow (15).

8. The milk-frothing device (1) as claimed in claim 1, wherein the opening cross section (10) is variable at least in a stepwise manner such that a throughflow of the milk and air flow (14) through the variable opening cross section (10) is adjustable at least in a stepwise.

9. The milk-frothing device (1) as claimed in claim 1, wherein the opening cross section (10) is variable by rotation of the regulating body (22) about a regulating axis (23).

10. The milk-frothing device (1) as claimed in claim 1, further comprising an air switching-off device, and the air flow is switchable on and off by the air switching-off device,
such that both milk froth and hot milk are deliverable from the milk-frothing device (1).

11. A method for producing milk froth (13) using a milk-frothing device (1) and for cleaning lower portions of a milk supply (12) of the milk-frothing device (1), the method comprising:
frothing air (6) and milk (7) in a mixing chamber (3) using a steam flow (9) to form the milk froth (13),
adjusting a milk flow (8) passing into the mixing chamber (3) using a variable opening cross section (10),
allowing the air (6) to flow through the variable opening cross section (10) into the mixing chamber (3),
the air (6) forming an air flow (15) which flows simultaneously with the milk flow (8) as a milk and air flow (14) through the variable opening cross section (10),
closing the milk supply (12) with a regulating body (22) with which the variable opening cross section (10) is adjustable,
an air supply (11) of the milk-frothing device (1) continuing to feed air to the opening cross section (10) while the milk supply (12) is interrupted, and
when the milk supply (12) is completely closed, directing a flushing water flow through the air supply (11).

12. The method as claimed in claim 11, further comprising adjusting or regulating the milk and air flow (14) by adjustment of the variable opening cross section (10).

13. The method as claimed in claim 12, wherein, by adjustment of the variable opening cross section (10), adjusting both the air flow (15) and the milk flow (8) at least one of simultaneously or synchronously.

14. The method as claimed in claim 11, further comprising increasing a temperature of the milk froth (13) by the milk and air flow (14) being reduced by reducing the opening cross section (10).

15. The method as claimed in claim 11, further comprising varying the opening cross section (10) by rotation of the regulating body (22) about a regulating axis (23) by which a depth, which determines the opening cross section (10), of a surface channel (24) on the regulating body (22) is varied.

16. The milk-frothing device (1) as claimed in claim 7, wherein the additional throughflow reducer (18) comprises a pinhole aperture (19), and the device further comprises a lip seal (20) for preventing a flowback of milk through the pinhole aperture.

17. The milk-frothing device (1) as claimed in claim 9, wherein the variable opening cross section (10) comprises a surface channel (24) on an outer circumferential side and of variable depth, on the regulating body (22), and the air (6) is guided to the variable opening cross section (10) by an air surface channel (25) which is formed on the regulating body (22) and opens into the surface channel (24).

18. The method of claim 13, further comprising dispensing with an additional active regulation of the air flow (15), and wherein air (6) and milk (7) always flow together through the variable opening cross section (10).

19. The method of claim 14, wherein the steam flow (9) is kept constant or is increased, and/or

20. The method of claim 14, further comprising reducing both the air flow (15) and the milk flow (8) by reducing the opening cross section (10).
